(19) United States
(12) Patent Application Publication
(10) Pub. No.: US 2014/0272759 A1
(43) Pub. Date: Sep. 18, 2014

(54) METHOD AND APPARATUS FOR TREATING MALOCCLUSIONS AND TEETH ALIGNMENT

(71) Applicant: Terry Dischinger, Lake Oswego, OR (US)

(72) Inventor: Terry Dischinger, Lake Oswego, OR (US)

(21) Appl. No.: 14/209,685

(22) Filed: Mar. 13, 2014

Related U.S. Application Data
(60) Provisional application No. 61/784,466, filed on Mar. 14, 2013.

(51) Int. Cl. A61C 7/36

(52) U.S. Cl. CPC A61C 7/36
USPC 433/19; 433/24

(57) ABSTRACT

A method and apparatus for moving malpositioned teeth to orthodontically correct positions and simultaneously positioning the lower dental arch of a patient relative to the upper dental arches that includes providing braces for securing to the upper and lower arches and providing a four section spring loaded telescopic rod for fastening a first end directly or indirectly at or near a lower molar and a second end directly or indirectly at or near an upper molar. The telescopic rod may resiliently urge extensively toward its elongated fully extended position to assist in dento-aveolar movement of the teeth for correcting the bite. The method and apparatus may also include providing a spring member for resiliently urging the telescoping rod extensively toward its elongated fully extended position to assist in dento-aveolar movement of the teeth for correcting the bite.

### RELATED APPLICATION

This application claims priority to U.S. provisional patent application, entitled METHOD AND APPARATUS FOR TREATING MALOCCLUSIONS AND TEETH ALIGNMENT, Application No. 61/784,466, filed Mar. 14, 2013 and incorporates it in its entirety.

### FIELD OF THE INVENTION

The present invention relates generally to methods and apparatus for treating malocclusions and teeth alignments, and more particularly relates to orthodontic kits that hold the apparatus parts, and methods for correcting patient malocclusions and/or teeth alignment.

### BACKGROUND ART

This section describes the background art of certain disclosed embodiments. There is no intention, either express or implied, that the background art discussed in this section legally constitutes prior art.

Orthodontic treatment involves movement of malpositioned teeth to orthodontically correct positions. During treatment, small orthodontic appliances known as brackets are often connected to anterior, bicuspid, and molar teeth, and an archwire is placed in a slot of each bracket. The archwire forms a track to guide movement of the brackets and the 24 associated teeth to desired positions for correct occlusion. Typically, the ends of the archwire may be held by appliances known as buccal tubes that are secured to a patient's molar teeth. The brackets, archwires, and buccal tubes are commonly referred to as “braces.”

For patients fitted with braces, inter-arch rubber bands may be employed in order to assist in the movement of teeth. A more correct alignment of a patient's teeth may help to improve their smile and may make their teeth fit together more comfortably when biting down.

The use of inter-arch rubber bands for alignment treatments, however, may have several drawbacks. For example, in order to be effective, patients who use inter-arch rubber bands quite often are asked to follow detailed directions in order to make sure their treatment provides optimal results and continues on schedule without prolonging the process.

For example, dental professionals may recommend that whenever the inter-arch rubber bands are taken out, they should be discarded and replaced with brand new ones. As a result, depending on the strength/thickness of the bands, and the patient's day-to-day activities, the patient might have to replace the rubber bands more than once every day. At a minimum, patients may be advised to change the rubber bands at least once a day.

As a result of the detailed directions concerning the orthodontic treatment, some patients especially younger ones may be noncompliant and not follow the directions including the prescribed frequency of replacement of rubber bands as well as other requirements for the orthodontic procedure. When this happens, in order to continue the procedure in an effective manner, a device such as one referred to as a Forsus appliance is used to replace the rubber bands in a manner such that there is no longer a need for replacing rubber bands. In this regard, the Forsus appliance cannot be removed from the mouth by the patient.

The Forsus appliance employs a pair of right and left appliances each having a long coil spring fixed at its rear end to either the upper first or the upper second molar in the back of the upper dental arch, and at its front end to the lower arch wire between the cuspid and first bicuspid toward the front of the lower dental arch. While such an arrangement can be effective for moving teeth, it can be uncomfortable in use due to the pair of long springs. Such an arrangement has little or no effect on correcting malocclusions which often times may need to be corrected in addition to the orthodontic movement of teeth.

The orthodontic treatment of some patients may include correcting the alignment of the upper dental arch, or maxillary jaw, with the lower dental arch, or mandible jaw. For example, certain patients have a condition referred to as a Class II malocclusion, or “overbite,” where the lower dental arch is located an excessive distance in a rearward direction relative to the location of the upper dental arch when the jaws are closed.

A number of approaches have been developed to treat Class II malocclusions. One of the most common approaches for treating a Class II malocclusion is to use an intra-oral orthodontic appliance known as a “Herbst” device. A conventional Herbst device is comprised of a sleeve and tube assembly. Typically, one component of the assembly is pivotally secured to a molar tooth in the upper arch, while another component is pivotally secured to a bicuspid or anterior tooth in the lower arch, or a cantilever arm in the lower arch. Oftentimes, both the sleeve and tube components are pivotally secured to an archwire, bracket, cap, or other orthodontic appliance associated with a particular tooth. Such a Herbst device is shown in U.S. Pat. No. 3,798,773 (1973), issued to Northcutt.

Herbst devices operate by forcing the lower arch into a desired occlusion position when the mouth is opened and closed. In other words, the Herbst devices prevent a patient from comfortably closing his or her mouth unless the lower arch is physically repositioned forward. If the arches are not repositioned, the sleeve of the Herbst device impacts a portion of the tube or an attachment connected to the tube so as to create a hard, fixed “stop” that is uncomfortable for the patient. To compensate for this uncomfortable stop the patient repositions their lower jaw forward. Eventually, the patient experiences muscular response such that the jaws begin to naturally close with the proper occlusion. Because Herbst devices were first developed in the early 1900's, their safety and reliability have been well documented.

Although Herbst devices have generally proven to be successful products, there are several concerns that limit their appeal and effectiveness. For example, Herbst devices are typically designed with long and stiff assemblies in order to withstand the significant forces exerted by the muscles of mastication. In addition to making the devices more noticeable within a patient's mouth, these large assemblies often create discomfort near the front of the mouth. Cheek muscles are relatively tighter around the anterior teeth than the posterior teeth and thus become easily irritated from tightly rubbing against the Herbst device.

Additionally, the anterior teeth have a tendency to flare or tip forward when they are connected to a Herbst device. While a conventional Herbst device may be used to correct a malocclusion at the same time that archwires and brackets are used to prevent this tipping, there are several significant challenges with doing so. Specifically, when the Herbst device extends from a molar on the upper arch to a bicuspid tooth or cantilever arm on the lower arch, the sleeve and tube assembly obstructs access to a large number of teeth. This obstruction makes it extremely difficult for practitioners to bond brackets to those teeth. Although some practitioners have attempted to circumvent this problem by welding extra parts onto the Herbst device or by placing the brackets in unusual positions, none of these ad-hoc approaches have proven to be a suitable solution.

As a result, many practitioners prefer to perform different treatment methodologies at different times. For example, a Herbst device may be used to correct a malocclusion prior to installing brackets for repositioning teeth. This separate treatment is undesirable to both the patient and practitioner because it not only increases the overall time that the patient must wear orthodontic appliances, but also increases the number of orthodontic modifications required to control the tipping of the anterior teeth. Such sequential procedures are not only time consuming for the patient, but also expensive to have two separate treatments.

However, as with the above described and other devices for treating malocclusions, once the malocclusion is corrected or substantially corrected, then it is often times necessary to straighten the teeth using braces. As mentioned previously, separate treatments are highly undesirable to both the patient and practitioner because it is not only necessary to increase the overall time that the patient must wear orthodontic appliances, but also increases the number of orthodontic modifications required to control the tipping of the anterior teeth as well as straightening malpositioned teeth.

While there have been several different attempts at making improved Herbst appliances, such as disclosed in U.S. Pat. Nos. 4,382,783; 5,645,424; 5,848,891; 5,848,891; and 5,980,247, none of them were designed to move teeth at the same time as providing jaw bone alignment. U.S. Pat. No. 7,578,671 discloses a technique for correcting jaw bone alignment for Class II malocclusions, which at the same time straightens the teeth. While such a technique has proven successful, it is not always entirely successful in both correcting the malocclusions and the teeth straightening simultaneously during the same interval of time usually set aside to perform the correction of a Class II malocclusions by itself. In this regard, frequently the malocclusion correction is completed satisfactorily but the movement of the teeth have not been completely corrected. Therefore, unwanted additional orthodontic correction and thus additional time and expense must be undertaken.

Therefore, it would be highly desirable to have a new and improved appliance and methods for completing both operations simultaneously and effectively within the same interval of time usually set aside to perform the Class II correction for malocclusions. Such an appliance should be very comfortable to use, and relatively inexpensive to manufacture.

### BRIEF DESCRIPTION OF THE DRAWINGS

The accompanying drawings, which are incorporated in and constitute a part of this specification, illustrate embodiments and the detailed description given below, serve to explain the principles of certain embodiments of the invention.

In order to better understand the invention and to see how the same may be carried out in practice, non-limiting preferred embodiments will now be described with reference to the accompanying drawings, in which:

FIG. 1 is a side view of an orthodontic device according to an embodiment, the orthodontic device being shown with an upper dental arch and lower dental arch of a patient in a closed position;

FIG. 2 is a side view similar to FIG. 1 showing the orthodontic device with the upper dental arch and lower dental arch in an open position;

FIG. 3 is a perspective view of the orthodontic device shown in FIG. 1;

FIG. 4 is a frontal view of the orthodontic device shown in FIG. 1;

FIG. 5 is a pictorial side view of an orthodontic device according to another embodiment, the orthodontic device being shown with an upper dental arch and lower dental arch of a patient in an open position;

FIG. 6 is an exploded, pictorial view of the upper dental arch attachment apparatus of the orthodontic device shown in FIG. 5;

FIG. 7 is a side view of a telescopic rod and coil spring of the orthodontic device according to another embodiment; and

FIG. 8 is a pictorial view of an orthodontic kit according to yet another embodiment.

### DETAILED DESCRIPTION OF CERTAIN EMBODIMENTS

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

According to an embodiment, there is disclosed a method and apparatus for moving malpositioned teeth to orthodontically correct positions and simultaneously or sequentially positioning the lower dental arch of a patient relative to the upper dental arch. Braces may be secured to the upper and lower arches. At least one telescoping rod may be employed. One end of a telescoping rod is fastened directly or indirectly at or near a lower molar. A second end of the telescoping rod may be fastened directly or indirectly at or near an upper molar. The spring loaded telescoping rod may be urged resiliently extensively toward its elongated fully extended position to assist in dento-aveolar movement of the teeth for correcting the bite.

In another embodiment, there is disclosed a method and apparatus for moving malpositioned teeth to orthodontically correct positions and simultaneously or sequentially positioning the lower dental arch of a patient relative to the upper dental arches that includes providing braces for securing to the upper and lower arches and providing a telescopic rod for fastening a first end directly or indirectly at or near a lower molar and a second end directly or indirectly at or near an upper molar. The telescopic rod may resiliently urges extensively toward its elongated fully extended position to assist in dento-aveolar movement of the teeth for correcting the bite. The method and apparatus may also include providing a spring member for resiliently urging the telescoping rod extensively toward their elongated fully extended position to assist in dento-aveolar movement of the teeth for correcting the bite step.

In yet another embodiment, there is disclosed a kit for moving malpositioned teeth to orthodontically correct positions and simultaneously or sequentially positioning the lower dental arch of a patient relative to the upper dental arch, wherein the teeth are fitted with braces. The kit may include two or more telescopic rods for directly or indirectly connecting between at or near lower and at or near upper molars and spring members for resiliently urging the telescoping rods extensively toward their elongated fully extended positions to assist in straightening teeth.

The embodiments of the method and apparatus as disclosed herein enable both the correction of malocclusions and the dento-aveolar movement of the teeth of a patient simultaneously. This avoids having unwanted and undesirable serial treatments. Moreover, the embodiments of the method and apparatus disclosed herein can be used at the option of the practitioner alternatively to perform the treatments serially. Thus, at the option of the practitioner, for example, the malocclusion can be treated first and then a resilient member may be added to the telescoping rod for providing the resilient urging to assist in the dento-aveolar movement of the teeth to complete the correction of the bite. Alternatively, also at the option of the practitioner, the malocclusion treatment and the teeth moving treatment can be performed simultaneously to correct the bite in a single treatment. Thus, the embodiments disclosed herein of the method and apparatus provide the practitioner with a highly efficient and flexible approach to treating patients.

With reference to FIGS. 1 through 4, an orthodontic device 10 according to an embodiment is shown. The orthodontic device 10 is generally designed to reposition a lower dental arch or mandible jaw 12, relative to an upper dental arch or maxillary jaw 14. By way of background, the upper arch 14 and lower arch 12 each include a set of anterior teeth 16, first and second bicuspid teeth 18, 20, and first and second molars 22, 24. A bracket 26 is secured to each tooth and an archwire 28 extends through the brackets 26 in order to provide each dental arch with a set of braces 30. The braces 30 help guide the teeth into the correct positions for proper occlusion.

As shown in the figures, the orthodontic device 10 comprises a telescopic rod 40 having a first end 42 and a second end 44 aligned along an axis 46. A first attachment member 50 associated with the first end 42 is generally aligned along the axis 46 and adapted to pivotally couple the telescopic rod 40 to the first molar 22 on the lower dental arch 12. Meanwhile, a second attachment member 52 associated with the second end 44 is generally offset from the axis 46 and adapted to pivotally couple the telescopic rod 40 to the first molar 22 on the upper dental arch 14.

A coil spring 53 surrounds the telescopic rod 42 to urge it resiliently extensively into its fully extended position. In this manner, the spring 53 applies sufficient force to assist in the teeth straightening treatment, while the telescopic rod 42 facilitates in adjusting the alignment of the jaws. It will be understood by those skilled in the art that different types and kinds of resilient members or may be employed. For example, and without limitation, elastic material, leaf springs and others may be employed, or alternatively, an interior spring member may be employed internally to the telescopic rod 42. Thus, there may be a variety of different resilient members which may be employed to assist in the movement of the teeth, and the resilient members may be positioned at different locations as will become apparent to those skilled in the art.

Those skilled in the art will appreciate that there are a number of ways to pivotally couple the telescopic rod 40 to the molars 22. For example, the first and second attachment members 50, 52 may each include an eyelet 58 for receiving a fastening member 60. The fastening members 60 may each be secured to a cap or band 62, archwire 28, bracket 26, and/or buccal tube (not shown) or other components on the associated first molar 22. In the embodiment shown in the figures, the fastening members 60 are screws that are adapted to engage a threaded bore (not shown) provided on each molar cap 62. Preferably, the threaded bore is provided in the middle of each molar cap 62. But the location of the bore may be altered as necessary to achieve a molar-to-molar connection. The screws 60 allow the first and second attachment members 50, 52 to pivot as the patient's jaws are opened and closed.

As shown in FIGS. 2 and 3, the telescopic rod 40 includes a plurality of tubes adapted to slide relative to each other along the axis 46 such that the telescopic rod 40 has an adjustable length. In one embodiment, the telescopic rod 40 includes four sections: an outer tube 70, a first intermediate tube 72 adapted to be slidably received in the outer tube 70, a second intermediate tube 74 adapted to be slidably received in the first intermediate tube 72, and an inner tube or rod 76 adapted to be slidably received in the second intermediate tube 74. Accordingly, the outer tube 70, first intermediate tube 72, and second intermediate tube 74 each include at least a hollow portion, whereas the inner tube 76 may or may not include a hollow portion. The sections of the telescopic rod 40 can be formed from different materials, such as metal, plastic, ceramic or other materials readily apparent to those skilled in this art. In addition, a coating can be applied over the different sections, such as Teflon® (PTFE) or other low friction material readily apparent to those skilled in this art. The advantages in coating the sections of the telescopic rod 40 include making the sections slide easier for improved comfort, reduced section binding and preventing potential breakage of the orthodontic device 10.

The inner tube 76 is coupled to a disc-shape portion 84 of the first attachment member 50. The disc-shaped portion 84 is adapted to contact an end surface 86 of the outer tube 70 and thus acts as a “stop” to prevent the inner tube 76 from extending through the other tubes when the dental arches are in a closed position (FIG. 1). The second attachment member 52 is coupled to an outer cylindrical surface 88 of the outer tube 70 adjacent second end 44. Both the first and second attachment members 50, 52 may be integrally formed with the respective tube to which they are coupled in order to simplify the construction of the orthodontic device 10. Also, note that the telescopic rod 40 may be arranged in other manners, such as with the second attachment member 52 coupled to an inner tube and the first attachment member 50 coupled to an outer tube.

With reference to FIG. 4, the first attachment member 50 is generally aligned in a plane 96 and the second attachment member 52 is generally aligned in a plane 98. The planes may be angled relative to each other, for example, at an angle a between approximately 7 and 18 degrees. In this manner, the first attachment member 50 is not directly aligned with the second attachment member 52. Such an arrangement facilitates coupling the first and second attachment members 50, 52 to the respective dental arches 12, 14. In order to achieve this orientation, at least one of the telescopic rod sections 70, 72, 74, 76 may be adapted to rotate about the axis 46 relative to the other sections 70, 72, 74, 76. Alternatively, the telescopic rod sections 70, 72, 74, 76 may be initially assembled with this orientation and prevented from rotating about the axis 46.

The operation of the orthodontic device 10 will now be described in further detail. FIG. 1 shows the upper arch 14 and lower arch 12 in a normal, closed position. Because of the offset of the second attachment member 52, the axis 46 of the telescopic rod 40 is aligned generally parallel to the occlusal plane. Such an arrangement helps maximize the horizontal force vectors exerted by the orthodontic device 10. The offset of the second attachment member 52 may also be designed to align the telescopic rod 40 with the gum line.

As shown in FIG. 2, the sections 70, 72, 74, 76 of the telescopic rod 40 slide relative to each other along the axis 46, and first and second attachment members 50, 52 pivot about the screws 60 in order to allow the patient's jaws to move into an open position. Because the telescopic rod 40 includes four slidable sections 70, 72, 74, 76, the range of expansion of the jaws is greatly enhanced. For example, the orthodontic device 10 preferably has a length of approximately 12 mm in the closed position and a length of at least approximately 34 mm in the open position, with the length being defined as the distance between the respective eyelets 58 of the first and second attachment members 50, 52 in a direction along the axis 46. Such an arrangement ensures that the orthodontic device 10 is able to maintain a molar-to-molar connection without significantly interfering with chewing, yawning, and other movements that require full expansion of the telescopic part of the appliance.

When the patient attempts to close his or her jaws, the outer tube 70 will slide over the other sections 72, 74, 76 of the telescopic rod 40 until the end surface 86 contacts the disc-shaped portion 84 of the first attachment member 50. If the lower arch 12 is positioned an excessive distance in a rearward direction relative to the location of the upper arch 14, the orthodontic device 10 will be angled relative to the occlusal plane and prevent the jaws from closing completely. Thus, in order to move the upper arch 14 and lower arch 12 into a closed position, the patient must force the lower arch 12 in a forward direction until the telescopic rod 40 is aligned substantially parallel with the occlusal plane. As with conventional Herbst devices, eventually the patient will experience muscular adaptation based upon this forced response and begin closing his or her jaws with the proper occlusion.

The embodiment shown in FIGS. 1 through 4 is particularly suited for patients having a fully erupted second molar 24. In these patients, contact between the second end 44 of the telescopic rod 40 and tissue 102 or the descending portion of the ramus is less of a concern. As shown in FIG. 1, the second attachment member 52 may extend substantially orthogonally from the outer tube 70 so that the second end 44 overlaps the second molar 24 on the lower dental arch 12. The fully erupted second molar 24 prevents contact with the tissue 102 and avoids the patient discomfort associated with such contact.

With reference to FIGS. 5-7, there is illustrated an alternative embodiment. Like reference numbers are used in the figures to refer to like elements from the embodiment discussed above, while like reference numbers with prime marks (′) represent corresponding elements that have been slightly modified as will be apparent from the description, the figures, or both.

The orthodontic device 10′ shown in FIGS. 5 and 6 operates under the same general principles that were discussed with respect to the embodiment shown in FIGS. 1 through 4, except that the device 10′ is connected in place in a different way. The orthodontic device 10′ comprises a telescopic rod 40 having a first end 42 and a second end 44 aligned along an axis 46. The device 10′ may also include a coil spring 53 that surrounds the telescopic rod 42 having four tubular sections to urge it resiliently extensively into its fully extended position. The four telescoping tubular sections enable the telescopic rod 42 to be small and compact in size, and thus more comfortable for the patient. A first attachment member 90 associated with the first end 42 is adapted to pivotally couple the telescopic rod 40 to the archwire 28 between the first molar 22 and a second bicuspid tooth 20 on the lower dental arch 12. Meanwhile, a second attachment member 92 associated with the second end 44 is adapted to pivotally couple the telescopic rod 40 to the archwire 28 on or near the first molar 22 on the upper dental arch 14. Thus, the device 10′ is positioned back in the mouth in a more comfortable position for the patient. As a result of the small size of device 10′ and its position in the mouth, the treatment is both safe and effective in correcting Class II malocclusions as well as malpositioned teeth simultaneously in the same time as normally set aside for Class II corrections. Additionally, attaching the device 10′ between the upper and lower archwires adds greatly with the ease of installation in the patient's mouth.

The first attachment member 90 may include a wire that may be hooked on one end so as to encircle the archwire 28. The wire may be crimped or squeezed so as to reduce or eliminate slippage or separation of the wire from the archwire 28.

The second attachment member 92 may include a cylindrical end cap 94 disposed around and over the first end 42 of the telescopic rod 40. One end of a support 97 is attached to the outer circumference of the cylindrical end cap 94 and the other end includes a hole 98. The second attachment member may also include a block connector 100 that is generally rectangular in shape and includes a pair of cylindrical transverse parallel spaced apart through holes 102 and 104. The holes 102 and 104 are substantially parallel to each other and span a width w of the block connector 100.

The block connector 100 is connected to the support 97 with a pin 107 that is inserted through hole 104 and having a head at one end and may be crimped at its opposite end to secure it in place with a fastener. The block connector 100 is coupled to and supported by the archwire 28 routed through hole 102. For example, and without limitation, other means of attachments may be used, such as screws, bolts, wires and others, for the attachment members 90 and 92 to couple to the archwires 28.

The embodiment shown in FIGS. 5 and 6 provides a less invasive system and method of coupling the telescopic rod 40 to the jaw and teeth because there is no bonding required to either attachment members 90 or 92. The orthodontist may simply run an archwire 28 from the upper jaw 14 to secure the second attachment member 92 and crimp the wire in the first attachment member 90 to an archwire 28 on the lower jaw 12.

The orthodontic device 10″ shown in FIG. 7 operates under the same general principles that were discussed with respect to the embodiment shown in FIGS. 5 and 6, except that the spring is removably attached to the outside of the device. The orthodontic device 10″ comprises a telescopic rod 40 having a first end 42′ and a second end 44′. In this embodiment, a first end 112 of a removable coil spring 53′ is attached to the first end 42′ at connection point 117, which may comprise a hole or opening. A second end 110 of the removable coil spring 53′ is attached to the second end 44′ at connection point 115, which may comprise a hole or opening. The removable coil spring 53′ is disposed away from and parallel to the telescopic rod 40. The removable coil spring 53′ also acts to resiliently urge the telescopic rod 40 into its fully extended position. The removable coil spring 53′ may be placed by the dentist onto the telescopic rod 40 at any time thus allowing flexibility for teeth straightening issues that arise after insertion and use of the telescopic rod 40. The fact that the spring may be removable allows for flexibility of treatment in that the spring may be connected in place at different times during the treatments at the discretion of the practitioner.

Therefore, the method and apparatus as disclosed herein may be used in different manners at the option of the practitioner. Also, by utilizing a resilient member such as a coil spring to assist in the movement of the teeth, the appliance is more comfortable for the patient since the resilient member is mounted at a rearward location in the mouth.

As shown in FIG. 8, the various components of the foregoing disclosed apparatus may be assembled to form an orthodontic kit 122, which may generally include two orthodontic devices 120 and 122 that comprise telescopic rods for directly or indirectly connecting between at or near lower and at or near upper molars, and spring members for resiliently urging the telescoping rods extensively toward their elongated fully extended positions to assist in dento-aveolar movement of the teeth. The orthodontic devices 120 and 122 are similar to device 10′ and to each other. The kit may also include a second pair of telescoping rods which are not equipped with resilient members such as springs for use in treating malocclusions, without having a separate teeth moving function provided by the resilient members. Thus, the kit would provide added flexibility for the practitioner. Alternatively, instead of providing the second pair of telescoping rods, the kit may include resilient members which are removable from their telescoping rods to provide the practitioner with using the telescoping members with or without their resilient members. Furthermore, the kit may also optionally include a set of the crowns of various sizes.

In other embodiments, the method of connection to the teeth may vary, and thus bands, crowns, connections to the arch wires or others may be employed. Crowns may be included in the kit, since it is presently contemplated that four different sized crowns may fit 90 percent of the patients. Also, no auxiliary customized parts such as cantilevers and others are required to be added to the crowns.

The kits may also use screws, wrenches and other components. The kit may or may not include braces.

By employing the embodiment of the kit, there is not only a comfortable appliance for the patient to use, but also the practitioner is afforded a great deal of flexibility in treating the bite of the patient. Additionally, by enabling the jaw to be repositioned at the same time as facilitating the dento-aveolar movement of the teeth, the overall treatment time may be greatly reduced such as being cut in half for some patients.

Also, by the use of the crowns which do not require auxiliary customized parts, unwanted and undesirable delays are avoided. In this regard, customized parts may require the practitioner to take impressions and send them to a laboratory to make the customized auxiliary parts, all of which necessitates delays in the treatment and the time spent with the patient. In many countries, there may not be laboratories nearby and the impressions may have to be sent a great distance away, thereby incurring greater delays.

Whereas, by using the embodiment of the crowns, no customization is required. Also, should any component part such as a crown, break during the treatment process, another crown can be installed immediately without having a laboratory make an expensive customized part.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. The various features of the different embodiments may be combined in any manner so as to be suitable and desirable for a given patient and/or condition. Accordingly, departures may be made from such details without departing from the scope or spirit of Applicants' general inventive concept.

What is claimed is:

1. A method for moving malpositioned teeth to orthodontically correct positions and simultaneously positioning the lower dental arch of a patient relative to the upper dental arch, comprising:
providing braces for securing to the upper and lower arches;
providing a four section spring loaded telescopic rod for fastening a first end directly or indirectly at or near a lower molar and a second end directly or indirectly at or near an upper molar; and
wherein the telescopic rod resiliently urges extensively toward its elongated fully extended position to assist in dento-aveolar movement of the teeth for correcting the bite.

2. A method according to claim 1, further including providing a spring member for the resiliently urging.

3. A method according to claim 2, wherein the telescopic rod includes four telescoping tubular sections.

4. An apparatus for moving malpositioned teeth to orthodontically correct positions and simultaneously positioning the lower dental arch of a patient relative to the upper dental arch, comprising:
braces for securing to the upper and lower arches;
four section spring loaded telescoping rods for fastening at or near lower molars and at or near upper molars; and
spring members for resiliently urging the telescoping rods extensively toward their elongated fully extended position to assist in dento-aveolar movement of the teeth for correcting the bite.

5. An apparatus according to claim 4, wherein the telescoping rods each include four telescoping tubular sections.

6. An apparatus according to claim 5, wherein the spring members are removably connected to the telescoping rods.

7. An apparatus according to claim 5, further including a block connector having at least one arch wire receiving through hole.

8. An apparatus according to claim 7, wherein the block connector further includes a pin receiving through hole.

9. A kit for moving malpositioned teeth to orthodontically correct positions and simultaneously positioning the lower dental arch of a patient relative to the upper dental arch, wherein the teeth are fitted with braces, the kit comprising:
two or more four section spring loaded telescopic rods for directly or indirectly connecting between at or near lower molars and at or near upper molars; and
spring members for resiliently urging the telescoping rods extensively toward their elongated fully extended positions to assist in straightening teeth.

10. A kit according to claim 9, further including a crown having a pair of tubes.
